(19) United States
(12) Patent Application Publication
(10) Pub. No.: US 2013/0272021 A1
(43) Pub. Date: Oct. 17, 2013

(54) DECORATION DEVICE AND GAME MACHINE

(71) Applicants: Koji Kirino, Ichinomiya-shi (JP); Junya Fujita, Ichinomiya-shi (JP)

(72) Inventors: Koji Kirino, Ichinomiya-shi (JP); Junya Fujita, Ichinomiya-shi (JP)

(73) Assignee: OMRON CORPORATION, Kyoto-shi, Kyoto (JP)

(21) Appl. No.: 13/825,809

(22) PCT Filed: Sep. 27, 2011
(86) PCT No.: PCT/JP2011/072090

§ 371 Date: Jul. 3, 2013

(30) Foreign Application Priority Data
Nov. 16, 2010 (JP) 2010-256128

(51) Int. Cl. F21V 33/00

(52) U.S. Cl. CPC F21V 33/008
USPC 362/605

(57) ABSTRACT

A decoration device (6) includes at least one light source (12) emitting light having directivity, a diffusion member (11a) having a diffuse reflective surface for diffusely reflecting light from the light source (12), and a light guide member (13) arranged around the diffusion member at a position anterior to the diffuse reflective surface. The light guide member (13) includes at least one incident surface (13a) facing the at least one light source (12) and an end face (13d) facing the diffusion member of the light guide member (13), wherein the light guide member (13) causes light from the light source (12), the light entering the light guide member (13) through the incident surface (13a), to propagate so as to spread within the light guide member (13), so that the light from the light source (12) exits from an area of the end face (13d), the area being larger than the incident surface (13a), toward the diffuse reflective surface (11a).

### TECHNICAL FIELD

The present invention relates to a decoration device using light from a light source and a game machine including such a decoration device.

### BACKGROUND ART

Traditionally, there has been provided a decoration device using a light source in a game machine such as a reel-type game machine (a slot machine) and a pinball game machine (a pachinko machine) in order to highlight the existence of the game machine to a player. Especially, in a game arcade, indoor lighting around an area in which reel-type game machines are placed is regulated to be rather dark, for example, approximately half of the illuminance of normal indoor lighting in a game arcade so that a player can visually recognize patterns of light emitting drums easily.

Further, in order to output sound effects creating a sense of actually being there, the sound effects being utilized for presentation of a game machine, a game machine may be provided with one or more acoustic speakers. Such an acoustic speaker is provided on a front surface as a design surface of an outer frame of a game machine, specifically, on an upper part of the design surface so that a player can easily hear sound effects. Therefore, an acoustic speaker is often arranged at a position that can be visually recognized easily by a player.

Accordingly, there has been proposed a game machine that attracts the interest of a player easily by illuminating a part or the periphery of an acoustic speaker which is provided in a game machine by using a light source such as a light-emitting diode (LED) (see Japanese Unexamined Patent Publication No. 2003-117082 and Japanese Unexamined Patent Publication No. 2009-118467, for example).

For example, in a speaker device disclosed in Japanese Unexamined Patent Publication No. 2003-117082, illumination units each having LEDs for decoration are provided on a case unit which is attached to the front side of a speaker body. Visible light output from the LEDs is reflected by a center cap or a cone of the speaker and then directed to a player.

Further, a speaker unit disclosed in Japanese Unexamined Patent Publication No. 2009-118467 is provided with a vibration body which generates sound waves and a frame which includes the vibration body inside thereof and has a mounting portion which is formed thereon and on which a magnetic circuit unit which causes the vibration body to vibrate is to be mounted. In the frame, the periphery thereof which is positioned outside the vibration body and the vibration body are formed of a light transmissive resin. Further, the frame is configured so that light from a light emitting unit which is positioned behind the frame penetrates the periphery of the frame and the vibration body.

Further, as a decoration device using a light source together with a speaker, there has been proposed, for example, a light emitting device that is configured in such a manner that an annular light guide body is disposed around a speaker which is provided in a radio-cassette player and the like, and light from a light source such as a LED is caused to be incident on the light guide body and then caused to exit from the light guide body in a sound output direction of the speaker (see Japanese Unexamined Patent Publication No. H09-212107).

### SUMMARY OF THE INVENTION

### Problems to be Solved by the Invention

In a technique disclosed in Japanese Unexamined Patent Publication No. 2003-117082, each of the LEDs for illuminating the cone is arranged so as to protrude into the front of the cone at the front side of the speaker body. Therefore, a part of sound exiting from the cone of the speaker body is reflected by the LEDs, which results in deterioration in the quality of sound emitted from a speaker. In addition, since light emitted from a LED has relatively high directivity, illumination unevenness of the cone or the center cap occurs. As a result, a high decoration effect may not be obtained.

Further, in a technique disclosed in Japanese Unexamined Patent Publication No. 2009-118467, since a light source is arranged behind a speaker, light emitted from the light source is blocked by a member of a speaker body. Therefore, it is impossible to evenly illuminate the entire cone. Further, when the periphery of the frame is processed for diffusely reflecting light, a ratio of light that penetrates toward the front side of the speaker to light from the light source is decreased. Therefore, in order to increase a decoration effect, it is necessary that the number of the light source be increased, or a high brightness light source be used. As a result, the power consumption of the light source is increased.

Further, in a technique disclosed in Japanese Unexamined Patent Publication No. H09-212107, although it is possible to cause light to exit from the entire light guide body so as not to cause illumination unevenness, the speaker itself is not illuminated and only the circumference of the speaker therefore glows when viewed from a player. Therefore, a high decoration effect may not be obtained.

Accordingly, it is an object of the present invention to provide a decoration device that is capable of evenly illuminating a member which is arranged on a front surface of a game machine and faces a player such as a vibration body of a speaker, and a game machine including such a decoration device.

### Means for Solving the Problem

As one aspect of the present invention, a decoration device is provided. The decoration device includes at least one light source emitting light having directivity, a diffusion member having a diffuse reflective surface for diffusely reflecting light from the light source, and a light guide member arranged around the diffusion member at a position anterior to the diffuse reflective surface. The light guide member includes at least one incident surface facing the at least one light source and an end face facing the diffusion member of the light guide member. The light guide member causes light from the light source, the light entering the light guide member through the incident surface, to propagate so as to spread within the light guide member, so that the light from the light source exits from an area of the end face, the area being larger than the incident surface, toward the diffuse reflective surface.

In the decoration device, it is preferred that the diffusion member is a vibration plate of a speaker, and the diffuse reflective surface is a surface of the vibration plate, the surface emitting sound.

Further, in the decoration device, it is preferred that the light guide member includes first and second reflective surfaces provided at a position facing the light source with the incident surface interposed therebetween and reflecting light from the light source, as a center, on an outer periphery of the light guide member, and a third reflective surface provided on the outer periphery of the light guide member and totally reflecting light reflected by the first reflective surface or the second reflective surface to direct the light to the end face of the light guide member.

Further, in the decoration device, it is preferred that the light guide member further includes an exit surface provided on a front surface of the light guide member, and the end face facing the diffusion member of the light guide member is formed into a tapered shape so that an inner diameter of the light guide member is decreased toward a front surface thereof in order to refract a part of light reaching the end face from an inside of the light guide member so as to exit toward the diffuse reflective surface and reflect the other part of the light reaching the end face so as to exit from the exit surface.

Further, preferably, the decoration device further includes a cover arranged in front of the diffuse reflective surface, and the cover is formed of a light transmissive member and provided with a plurality of holes through which the diffuse reflective surface can be visually recognized directly from a front side of the cover in which light diffusely reflected by the diffuse reflective surface is further diffused by at least a part of a circumference of the holes.

As another aspect of the present invention, a game machine including a game machine body, and a decoration device provided on a surface of the game machine body, the surface facing a player, is provided. In the game machine, the decoration device includes at least one light source emitting light having directivity, a diffusion member having a diffuse reflective surface for diffusely reflecting light from the light source, and a light guide member arranged around the diffusion member at a position anterior to the diffuse reflective surface. Further, the light guide member includes at least one incident surface facing the at least one light source and an end face facing the diffusion member of the light guide member. The light guide member causes light from the light source, the light entering the light guide member through the incident surface, to propagate so as to spread within the light guide member, so that the light from the light source exits from an area of the end face, the area being larger than the incident surface, toward the diffuse reflective surface.

### Effect of the Invention

The decoration device and the game machine according to the present invention have an effect of being able to evenly illuminate a member which is arranged on a front surface of a game machine and faces a player such as a vibration body of a speaker.

### BRIEF DESCRIPTION OF THE DRAWINGS

FIG. 1 is a schematic configuration diagram of a pinball game machine which is provided with decoration devices according to an embodiment of the present invention.

FIG. 2 is a schematic rear view of the pinball game machine shown in FIG. 1.

FIG. 3 is an exploded perspective view of one of the decoration devices in a state where a speaker body is attached to an outer frame.

FIG. 4A is an exploded perspective view of the decoration device excluding a cover when viewed from the front side thereof.

FIG. 4B is an exploded perspective view of the decoration device excluding the cover when viewed from the rear side thereof.

FIG. 5A is a schematic side view of the decoration device excluding the cover.

FIG. 5B is a schematic cross-sectional view of the decoration device taken along a plane passing through the center of the decoration device and perpendicular to a front surface of the pinball machine.

FIG. 6A is a schematic rear view of a light guide member.

FIG. 6B is an enlarged view of region B in FIG. 6A.

FIG. 6C is a schematic cross-sectional view of the light guide member taken along line A-A′ in FIG. 6A.

FIG. 7A is a ray tracing view when a part of the light guide member is viewed from the lateral side thereof.

FIG. 7B is a ray tracing view when the part of the light guide member is viewed from the front side thereof.

FIG. 8 is a schematic cross-sectional view of a light guide member according to a variation.

### MODE FOR CARRYING OUT THE INVENTION

Hereinafter, a decoration device according to an embodiment of the present invention will be described with reference to the drawings. The decoration device expands light emitted from light sources which are provided around a speaker body by using a light guide member which is provided around the speaker body. Further, the light guide member causes a part of the expanded light to exit toward a cone of a speaker and also causes the other part of the expanded light to exit toward a player. Accordingly, the decoration device can evenly illuminate the entire cone and also causes an area surrounding the speaker body to glow, thereby improving decoration effect.

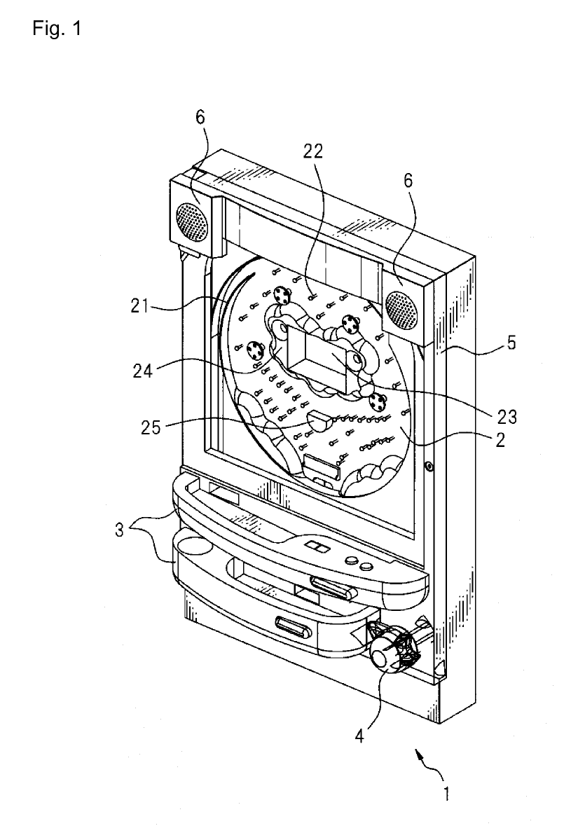

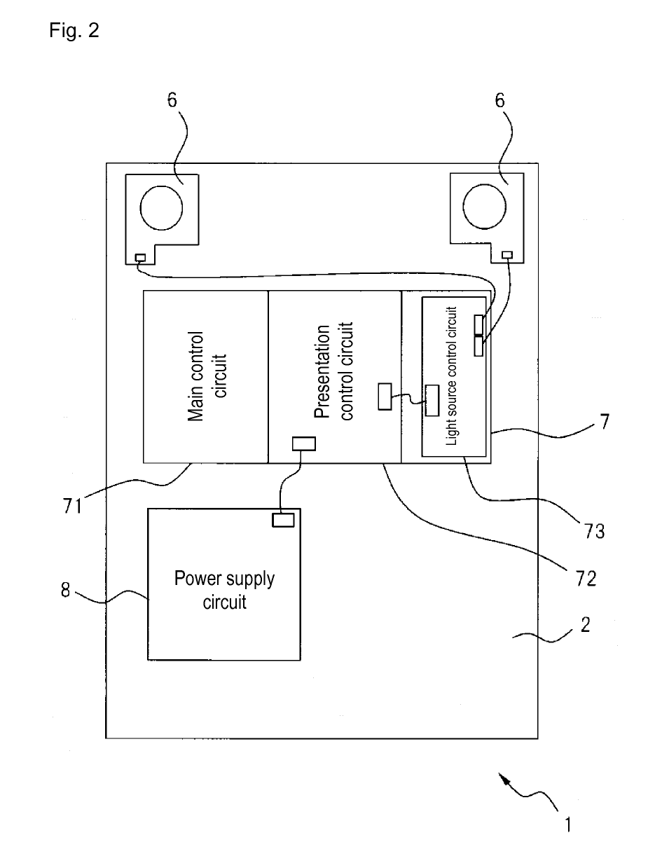

FIG. 1 is a schematic perspective view of a pinball game machine which is provided with decoration devices according to an embodiment of the present invention when viewed from a player. Further, FIG. 2 is a schematic rear view of the pinball game machine 1 shown in FIG. 1. The pinball game machine 1 includes a game board 2 which is provided so as to cover the greater part from an upper part through a central part of the pinball game machine 1, a ball receiving portion 3 and an operation unit 4 both of which are disposed in a lower part thereof, an outer frame 5 which is arranged on an outer periphery of the game board 2 and constitutes a game machine body together with the game board 2, decoration devices 6, a control circuit 7, and a power supply circuit 8. Further, the pinball game machine 1 includes a ball paying-out device (not shown) which temporarily stores game balls and pays out a predetermined number of game balls to the ball receiving portion 3 according to a control signal from the control circuit 7.

In response to an operation by a player, the operation unit 4 discharges a game ball from a discharge device (not shown) with a predetermined force depending on the turning amount of the operation unit 4. The discharged game ball moves upward along a rail 21 which is provided in a lateral part of the game board 2, and then falls through gaps between multiple obstacle nails 22 which are provided on the game board 2. On the game board 2, there are disposed, in addition to the obstacle nails 22, a display device 23 which includes a liquid crystal display and the like and provides a player with various information, a generator 24 which is provided around the display device 23 and used in presentation of a game, and one or more prize winning devices 25 by which a player can obtain a plurality of game balls when a game ball enters any of the prize winning devices 25. Further, when a game ball enters any of the prize winning devices 25, the control circuit 7 pays out a predetermined number of game balls depending on the prize winning devices 25 that the game ball enters into the ball receiving portion 3 through the ball paying-out device (not shown). Further, the control circuit 7 causes various images depending on the state of the game to be displayed on the display device 23.

The decoration device 6 according to an embodiment of the present invention is attached to each of an upper left edge and an upper right edge of the outer framed 5 at the front side of the game board 2. Further, as will be described later, the decoration device 6 has a speaker and light sources, and is configured to output sound depending on the state of a game in response to a signal from the control circuit 7, cause light to blink, and change emission colors or the amount of light to thereby increase the interest of a player.

Next, the decoration device 6 will be described in detail.

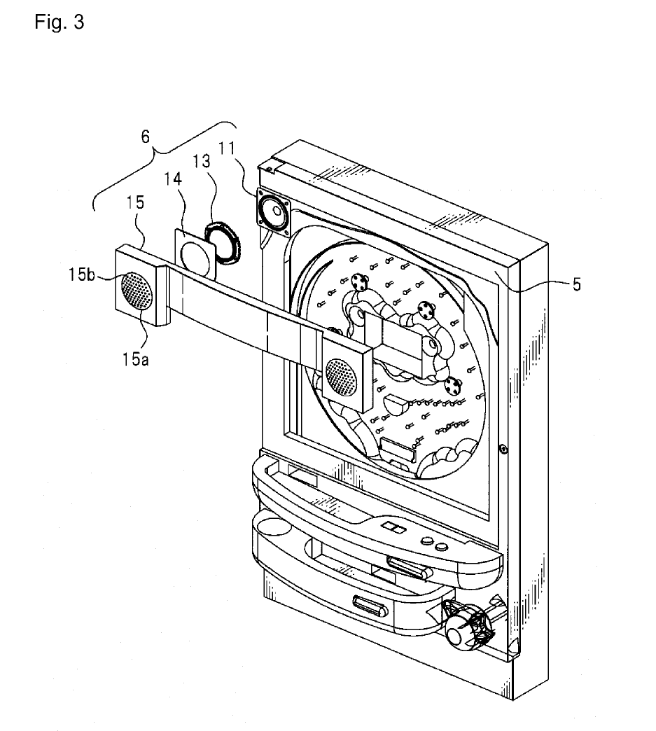

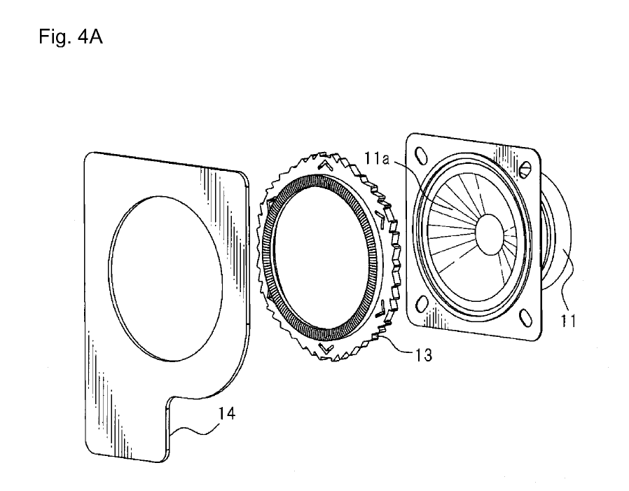

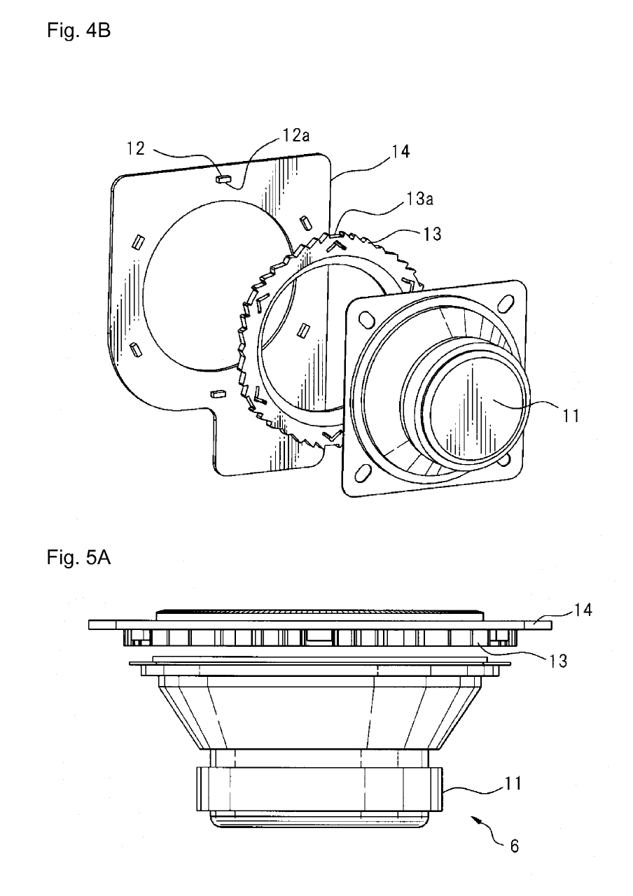

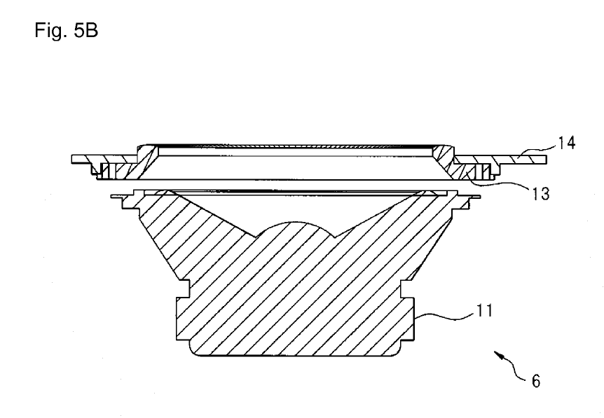

FIG. 3 is an exploded perspective view of one of the decoration devices 6 in a state where a speaker body is attached to the outer frame 5. In order to simplify the figure so as to be easily viewable, in a right side decoration device 6 when viewed from a player, components thereof other than a cover are omitted. Further, FIG. 4A is an exploded perspective view of the decoration device 6 excluding the cover when viewed from the front side thereof, FIG. 4B is an exploded perspective view of the decoration device 6 excluding the cover when viewed from the rear side thereof. Further, FIG. 5A is a schematic side view of the decoration device 6 excluding the cover; and FIG. 5B is a schematic cross-sectional view of the decoration device 6 taken along a plane passing through the center of the decoration device 6 and perpendicular to a front surface of the pinball machine 1.

As shown in FIG. 3, FIG. 4A, FIG. 4B, FIG. 5A, and FIG. 5B, the decoration device 6 includes a speaker body 11, a plurality of light sources 12, a light guide member 13, a substrate 14, and a cover 15.

The speaker body 11 outputs sound in response to a sound signal received from the control circuit 7. Therefore, the speaker body 11 includes a vibration plate 11a which generates aerial vibration and a magnetic circuit (not shown) which causes the vibration plate 11a to vibrate depending on a waveform of the sound signal. In the present embodiment, the vibration plate 11a is an example of a diffusion member. The vibration plate 11a is made of an opaque material such as paper, resin and metal, and formed into a cone shape. Further, the vibration plate 11a is arranged to be concave when viewed from a player. Further, the shape of the vibration plate 11a is not limited to a cone shape. The vibration plate 11a may be formed into, for example, a polygonal pyramid, or may have a flat plate shape or dome shape. Further, a front surface of the vibration plate 11a, namely, a surface that faces a player and emits a sound wave is, for example, roughened so as to be a diffuse reflective surface which diffusely reflects light from the light sources 12.

Each of the light sources 12 includes one or more light emitting elements which emit light having directivity, and a drive circuit. In the present embodiment, each of the light sources 12 includes a red LED, a green LED, and a blue LED as the light emitting elements. Further, each of the light sources 12 turns off all of the light emitting elements, or turns on at least one of the light emitting elements in response to a control signal from the control circuit 7. Further, the control circuit 7 may adjust the amount of light emitted from the light emitting elements of each of the light sources 12 by, for example, pulse width modulation. Each of the light sources 12 may include a white LED as the light emitting element, or may include any one of a red LED, a green LED, and a blue LED. Further, each of the light sources 12 may include a light emitting element which emits light having a different color from colors of light emitted from light emitting elements of the other light sources 12.

As shown in FIG. 4B, the light sources 12 (six light sources in the present embodiment) are attached to a rear surface of the substrate 14 which is provided on a front surface of the speaker body 11 along the outer periphery of the speaker body 11 at substantially equal intervals. Further, the rear surface of the substrate 14 is a surface that does not face a player, but faces in the same direction as a rear surface of the game board 2 in a state where the decoration device 6 is attached to the pinball game machine 1. Further, each of the light sources 12 is arranged so that a light emitting surface 12a thereof faces toward a central axis which passes through the center of the vibration plate 11a and is perpendicular to the front surface of the game board 2 so as to face an incident surface 13a of the light guide member 13.

Further, the number of light sources provided in the decoration device 6 is not limited to six, as long as the number is one or more. However, the number of light sources is preferably at least the smallest number that makes it possible to evenly illuminate the vibration plate 11a when the light sources are arranged along the outer periphery of the speaker body 11 at substantially equal intervals and all of the light sources are turned on.

The light guide member 13 expands light from the light sources 12. The light guide member 13 illuminates the vibration plate 11a of the speaker body 11 by a part of the expanded light, and also causes the other part of the expanded light to exit directly toward a player. Therefore, the light guide member 13 has generally the same shape as the shape of the outer periphery of the vibration plate 11a. In the present embodiment, the light guide member 13 has a generally ring-like shape. Further, the inner diameter of the light guide member 13 is substantially equal to the outer diameter of the vibration plate 11a. Further, the light guide member 13 is arranged between the substrate 14 and the speaker body 11, that is, arranged anterior to the vibration plate 11a so that the central axis of the vibration plate 11a is substantially the same as a central axis of the light guide member 13. By arranging the light guide member 13 in this manner, the light guide member 13 does not have a portion that protrudes into the front of the vibration body 11a. Therefore, a sound wave emitted from the vibration plate 11a toward the front side thereof is not blocked by the light guide member 13. As a result, deterioration of the quality of sound emitted from the vibration plate 11a can be prevented.

Further, the light guide member 13 is made by molding a resin that is transparent to visible light such as polymethyl methacrylate (PMMA) and polycarbonate (PC). Alternatively, the light guide member 13 may be made by grinding or molding glass.

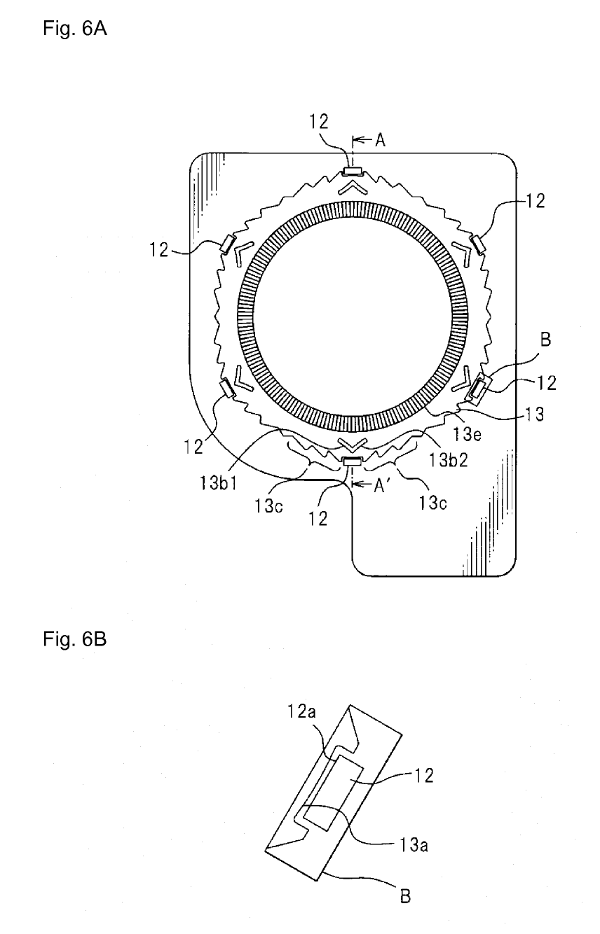

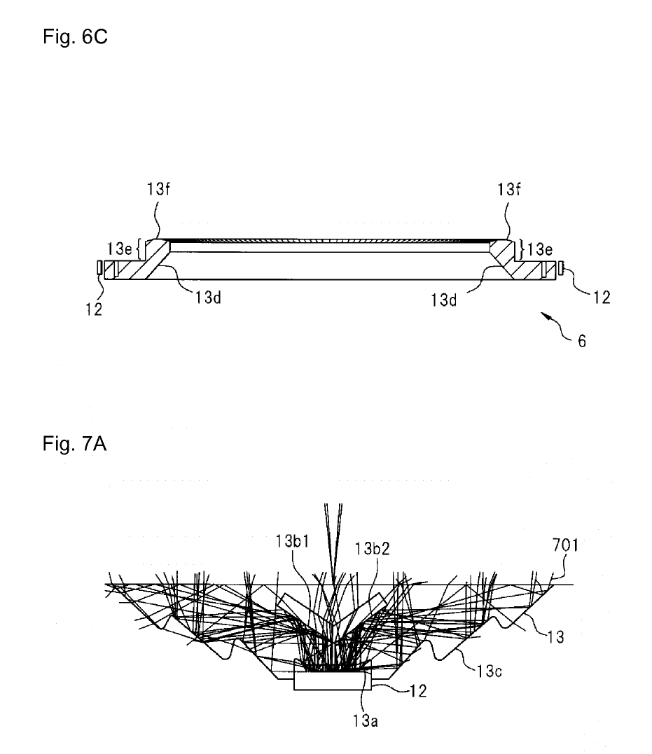

FIG. 6A is a schematic rear view of the light guide member 13; FIG. 6B is an enlarged view of region B in FIG. 6A; and FIG. 6C is a schematic cross-sectional view of the light guide member 13 taken along line A-A′ in FIG. 6A.

In the light guide member 13, there are formed two reflective surfaces 13b1 and 13b2 (a first reflective surface and a second reflective surface) which face the light source 12 with the incident surface 13a interposed therebetween so that light from the light source 12 propagates so as to spread to both sides of the incident surface 13a within the light guide member 13. The reflective surfaces 13b1 and 13b2 are arranged so that a vertex between the reflective surfaces 13b1 and 13b2 is located on a normal line of the incident surface 13a, the normal line passing through the center of the incident surface 13a, and each of the reflective surfaces 13b1 and 13b2 comes closer to an inner peripheral side end face of the light guide member 13 with increasing distance from the vertex. That is, the reflective surfaces 13b1 and 13b2 are arranged so as to be line-symmetric with respect to the normal line of the incident surface 13a from the vertex to thereby form a convex shape when viewed from the incident surface 13a. Each of the reflective surfaces 13b1 and 13b2 is formed in such a manner that a slit-like air gap is provided on a portion of a reflective surface of the light guide member 13. In this case, an angle between the normal line of the incident surface 13a and each of the reflective surfaces 13b1 and 13b2 is adjusted so that at least a part of light emitted from the light source 12 is totally reflected by the reflective surfaces 13b1 and 13b2. Alternatively, each of the reflective surfaces 13b1 and 13b2 may be formed by embedding a metal film into the light guide member 13.

The position and the shape of each of the reflective surfaces 13b1 and 13b2 are determined by, for example, performing ray tracing to evaluate the spread of light on the basis of the directional pattern of the light emitting element provided in the light source 12, the size and the refractive index of the light guide member 13, and a positional relationship between the reflective surfaces 13b1 and 13b2 and the light source 12 so that light from the light source 12 substantially evenly spreads to both sides of the incident surface 13a. For example, each of the reflective surfaces 13b1 and 13b2 may be a plane mirror, or may also be a concave mirror or a convex mirror. Further, each of the reflective surfaces 13b1 and 13b2 may be an aspherical surface. Also, the incident surface 13a may be a plane surface, or may also be formed into a spherical surface or an aspherical surface so as to be convex or concave with respect to the light emitting surface 12a. Further, each of the incident surface 13a and the reflective surfaces 13b1 and 13b2 may have different curvatures between a direction along the central axis of the light guide member 13 and the circumferential direction.

Further, the reflective surfaces 13b1 and 13b2 may be configured so that the amount of light reflected toward the left side of the incident surface 13a and the amount of light reflected toward the right side of the incident surface 13 are different from each other. In this case, the shape and the size of the reflective surface 13b1 may be different from the shape and the size of the reflective surface 13b2.

The light reflected by the reflective surface 13b1 and the light reflected by the reflective surface 13b2 respectively travel toward the right side and the left side of the incident surface 13a which is located on the outer periphery of the light guide member 13. Therefore, on the outer periphery of the light guide member 13, sawtooth wave-shaped reflective surfaces 13c (third reflective surfaces) are formed along the circumferential direction of the light guide member 13 to totally reflect the light reflected by the reflective surface 13b1 and the light reflected by the reflective surface 13b2 so as to be directed toward the inner periphery of the light guide member 13. In the present embodiment, three reflective surfaces 13c are formed on each side of the incident surface 13a so as to be line-symmetric with respect to the normal line of the incident surface 13a, the normal line passing through the center of the incident surface 13a. The size of each of the reflective surfaces 13c and an angle between each of the reflective surfaces 13c and the normal line of the incident surface 13a are determined by, for example, performing ray tracing to evaluate the spread of light so that light from the light source 12 substantially evenly spreads throughout the inner periphery of the light guide member 13. Therefore, the angle between each of the reflective surfaces 13c and the normal line of the incident surface 13a and the shape of each of the reflective surfaces 13c may be different from one to the other. Further, each of the reflective surfaces 13c may be formed into a concave shape or convex shape.

Further, an inner peripheral side end face 13d of the light guide member 13 is formed so as to face the vibration plate 11a. In the present embodiment, an expression such as “the end face 13d faces the vibration plate 11a” means that the end face 13d is arranged so that at least a part of the vibration plate 11a can be seen from the end face 13d. Further, the end face 13d is formed into a tapered shape in which the inner diameter at the rear side is larger than the inner diameter at the front side so that a part of light that has been reflected by the outer periphery of the light guide member 13 is refracted by the inner peripheral side end face 13d and thereby directed to the vibration plate 11a of the speaker body 11, and the other part of the light is reflected by the end face 13d and thereby directed to an exit surface 13f of a ring-shaped protruding portion 13e which protrudes toward the front side along the inner periphery of the light guide member 13.

An angle formed by the inner peripheral side end face 13d and a rear surface of the light guide member 13 is optimized depending on the refractive index of the light guide member 13, the shape of the vibration plate 11a, and the positional relationship between the light guide member 13 and the vibration plate 11a.

Further, light from the light source 12 is divided and reflected by the two reflective surfaces 13b1 and 13b2 which face in different directions from each other, and reflected at least twice within the light guide member 13. Therefore, an optical path length of the light is made to be long. As a result, the reflected light exits from an area of the end face 13d, the area being larger than the incident surface 13a, and then travels to the vibration plate 11a. As a result, the vibration plate 11a is illuminated over a larger area thereof than a case where the vibration plate 11a is directly illuminated by the light sources 12.

Further, the exit surface 13f which is a front side end face of the protruding portion 13e of the light guide member 13 is preferably subjected to surface roughening so as to diffuse light that is reflected by the end face 13d and then exits from the light guide member 13 through the exit surface 13f. Further, a diffusion sheet and the like according to letters and figures may be stuck to the exit surface 13f.

Further, for example, a thin metal film may be vapor-deposited onto the front surface of the light guide member 13 to thereby reflect light that has reached the front surface of the light guide member 13 toward the rear surface thereof so that light from the light sources 12 is not directly directed to a player, but a greater part of the light illuminates the vibration plate 11a.

FIG. 7A is a ray tracing view regarding one of the light sources when a part of the light guide member 13 is viewed from the rear side thereof, and FIG. 7B is a ray tracing view when the part of the light guide member shown in FIG. 7A is viewed from the lateral side thereof. In FIG. 7A and FIG. 7B, each of a plurality of lines 701 indicates a single ray of light. As shown in FIG. 7A and FIG. 7B, light emitted from the light source 12 propagates within the light guide member 13 through the incident surface 13a. Then, the greater part of the light is reflected by the reflective surface 13b1 or the reflective surface 13b2, further reflected by the reflective surface 13c, and then travels toward the inner peripheral end face of the light guide member 13. A part of the light reflected by the reflective surface 13c is refracted by the end face 13d and directed toward the vibration plate 11a. The other part of the light is reflected by the end face 13d and then exits from the protruding portion 13e. As just described, it is understood that the light from the light source 12 substantially equally spreads to both sides of the light source 12, so that the vibration plate 11a is evenly illuminated.

The substrate 14 is provided on the front surfaces of the speaker body 11 and the light guide member 13. Further, each of the light sources 12 is fixed to the rear surface of the substrate 14, and the speaker body 11 is also fixed thereto with a screw and the like. Further, a substantially circular hole having an inner diameter that is substantially equal to the outer diameter of the protruding portion 13e on the front surface of the light guide member 13 is formed on the substrate 14. The protruding portion of the light guide member 13 is fitted into the hole, so that the light guide member 13 is fixed thereto.

Further, a screw hole for attaching the decoration device 6 to the outer frame 5 of the pinball game machine 1 may be formed on the substrate 14.

The cover 15 is provided at the side of the front surface of the substrate 14 and attached to the outer frame 5. Further, as shown in FIG. 3, the cover 15 includes protection portions 15a each of which is positioned in front of the speaker body 11 in a state where the decoration device 6 is attached to the outer frame 5. A plurality of mesh-like holes 15b are formed on the protection portion 15a, thereby preventing the speaker body 11 from being touched by a player and also making it possible for a player to visually recognize the vibration plate 11a of the speaker body 11 and the light guide member 13 through the holes 15b. Therefore, a player can see light that is diffusely reflected by the vibration plate 11a and light that exits from the light guide member 13. Further, the protection portion 15a may be formed into a slit-like shape or a two-dimensional cross grating shape.

The cover 15 is formed of an opaque resin or metal. However, the protection portion 15a may be formed of a transparent resin such as PMMA and PC. By forming the protection portion 15a by a transparent member in this manner, a player can visually recognize the whole vibration plate 11a illuminated by the light sources 12 and the whole front surface 13f of the protruding portion 13e from which light exits, thereby making it possible to further increase the interest of a player. Furthermore, in at least a part of the circumference of the holes 15b formed on the protection portion 15a, at least any one of the front surface and the rear surface of the protection portion 15a may be roughened so as to diffuse light, or the protection portion 15a may include, inside thereof, a plurality of particles of macromolecule, metal, or the like having a refractive index that is different from the refractive index of the protection portion 15a for diffusing light.

Since the protection portion 15a further diffuses light in this manner, it is possible to make a player feel a stereoscopic effect by a combination of light diffused from the protection portion 15a and light diffusely reflected by the vibration plate 11a. As a result, the interest of a player can be further increased.

As shown in FIG. 2, the control circuit 7 and the power supply circuit 8 which supplies power to each of units of the pinball game machine 1 are attached to the rear surface of the game board 2. Further, the control circuit 7 controls each of the units of the pinball game machine 1. Therefore, the control circuit 7 includes a main control circuit 71 which controls a ball paying-out device (not shown) and the like, a presentation control circuit 72 which causes an image depending on the state of a game to be displayed on the display device 23 and outputs a sound signal to the speaker body 11 of each of the decoration devices 6, and a light source control circuit 73 which controls each of the light sources 12 of the decoration devices 6.

The presentation control circuit 72 includes, for example, a non-volatile semiconductor memory and an operation circuit, and determines as to whether or not each of the light sources 12 is turned on according to a program for presentation which is stored in the semiconductor memory and the state of a game. Further, when each of the light sources 12 has a plurality of light emitting elements which emit different colors of light from each other, the presentation control circuit 72 may determine as to whether or not each of the light emitting elements is turned on. Further, the presentation control circuit 72 determines the amount of light of each of the light emitting elements to be turned on. For example, the presentation control circuit 72 may make a blinking cycle of each of the light sources 12 shorter, or may increase the light emitting amount as the amount of sound emitted from the speaker which is determined according to the program for presentation and the state of the game increases. Alternatively, the presentation control circuit 72 may sequentially turn on light emitting elements provided in the light sources 12, the light emitting elements emitting light of the specific color, in the clockwise direction or the counterclockwise direction for a certain period of time so that the light of the specific color can be seen as rotating. In this case, the presentation control circuit 72 may control each of the light sources 12 so that the rotational speed of the light of the specific color is made faster as the amount of sound emitted from the speaker increases.

The presentation control circuit 72 is connected to the light source control circuit 73, and outputs, to the light source control circuit 73, a light source control signal indicating the amount of light when each of the light emitting elements of each of the light sources 12 is turned on or off, or turned on.

The light source control circuit 73 is connected to the drive circuit provided in each of the light sources 12, and outputs a drive signal, to each of the light sources 12, to turn on or off the light emitting elements provided in each of the light sources 12 with a predetermined amount of light by, for example, pulse width modulation, depending on the light source control signal. Further, for example, any of various known control circuits for controlling light emitting elements can be used as the light source control circuit 73. Therefore, a description regarding a detailed configuration of the light source control circuit 73 will be omitted.

As described above, the decoration device can evenly illuminate the vibration plate of the speaker body by using a plurality of low power consumption light sources such as LEDs. In addition, in the decoration device, the light sources and the light guide member are arranged around the vibration plate and therefore do not protrude into the front of the vibration plate. Accordingly, it is possible to prevent sound output from the speaker body from being distorted by the light sources and the light guide member.

Further, the present invention is not limited to the above embodiment. For example, each of the light sources may be arranged along the outer periphery of the speaker body at a position closer to the rear surface of the game board than the vibration plate of the speaker body and the light guide member.

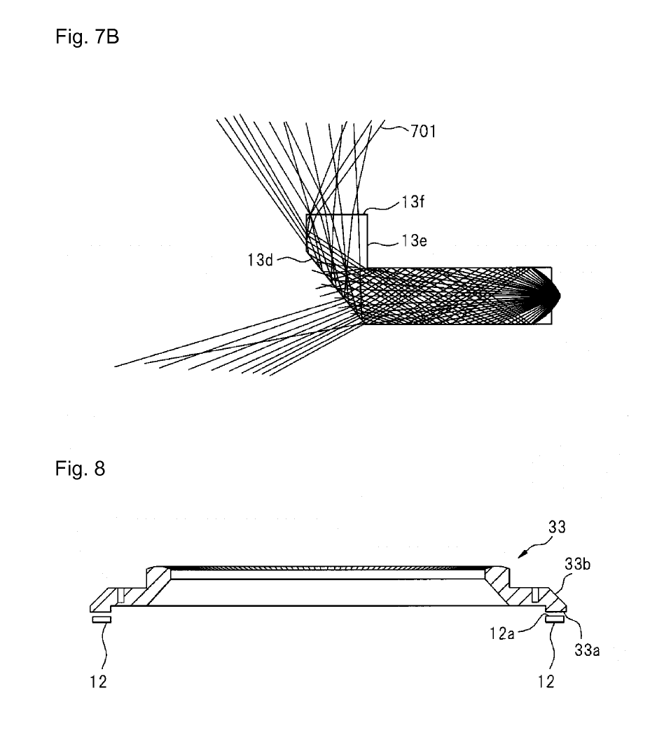

FIG. 8 is a schematic cross-sectional view of a light guide member according to this variation. A light guide member 33 according to the variation has the same shape as the shape of the light guide member 13 according to the above embodiment excepting the shapes of an incident surface 33a and an outer periphery near the incident surface 33a. In this variation, each of the light sources 12 is arranged so that the light emitting surface 12a thereof faces in the same direction as the front surface of the game board. Further, the incident surface 33a of the light guide member 33 is arranged so as to face in the same direction as the rear surface of the game board so that the incident surface 33a faces the light emitting surface 12a of the light source 12. Further, a front surface side end face 33b of the light guide member 33, the front surface side end face 33b being positioned on opposite side of the incident surface 33a of the light guide member 33, is formed into a tapered shape so as to totally reflect light from the light source 12, the light entering the end face 33b through the incident surface 33a, so that the reflected light is directed toward the inner periphery of the light guide member 33.

Further, according to another embodiment, a light guide member may be formed of a plurality of members. For example, a decoration device may include a single light guide member for each light source, the light guide member being formed so as to be bilaterally symmetric with respect to a normal line of an incident surface which faces a light emitting surface of the light source. In this case, each of the light guide member has a shape formed by cutting the light guide member shown in FIG. 6A in lines each of which connects the center between adjacent ones of the light sources with the center of the light guide member. Further, a plurality of light sources are arranged along the outer periphery of a vibration plate at substantially equal intervals. In addition, the light guide members corresponding to the respective light sources are also arranged so as to surround the outer periphery of the vibration plate.

Further, according to another embodiment, a diffuse reflective member which is illuminated by light exiting from a light guide member may not be a vibration plate of a speaker. For example, the diffuse reflective member may be a part of an outer frame of a game board. Also in this case, the diffuse reflective member may have a cone shape, a polygonal pyramid shape, or a hemispherical shape so as to form a convex or concave surface with respect to a player. Further, a surface of the diffuse reflective member is subjected to surface roughening so as to diffusely reflect light. Further, a cover may be omitted.

Further, the decoration devices of the above embodiments or variations thereof may be installed in a reel-type game machine. Further, the position of the decoration device is not limited to each of the upper left edge and upper right edge of the outer frame. The decoration device may be disposed on the outer frame or the game board at a position that can be visually recognized by a player so that the diffuse reflective surface of the diffuse reflective member faces a player.

Further, the decoration device may be mounted in other game machines, or various devices or equipment utilizing decoration which uses illumination light.

In this manner, various changes can be made according to embodiments by those skilled in the art within the scope of the invention.

### DESCRIPTION OF SYMBOLS

1 Pinball game machine
2 Game board
3 Ball receiving portion
4 Operation unit
5 Outer frame
6 Decoration device
7 Control circuit
8 Power supply
9 Speaker body
10 Light source
12a Light emitting surface
13 Light guide member
13a Incident surface
13b1 Reflective surface (First reflective surface)
13b2 Reflective surface (Second reflective surface)
13c Reflective surface (Third reflective surface)
13d End face
13e Protruding portion
13f Exit surface
14 Substrate
15 Cover
15a Protection portion
21 Rail
22 Obstacle nail
23 Display device
24 generator
25 Prize winning device

1. A decoration device comprising:
at least one light source emitting light having directivity;
a diffusion member having a diffuse reflective surface for diffusely reflecting light from the light source; and
a light guide member arranged around the diffusion member at a position anterior to the diffuse reflective surface,
the light guide member including
at least one incident surface facing the at least one light source and an end face facing the diffusion member, wherein
the light guide member causes light from the light source, the light entering the light guide member through the incident surface, to propagate so as to spread within the light guide member, so that the light from the light source exits from an area of the end face, the area being larger than the incident surface, toward the diffuse reflective surface.

2. The decoration device according to claim 1, wherein the diffusion member is a vibration plate of a speaker, and the diffuse reflective surface is a surface of the vibration plate, the surface emitting sound.

3. The decoration device according to claim 1,
wherein the light guide member includes:
first and second reflective surfaces provided at a position facing the light source with the incident surface interposed therebetween and reflecting light from the light source toward different directions from each other from the incident surface, as a center, on an outer periphery of the light guide member; and
a third reflective surface provided on the outer periphery of the light guide member and totally reflecting light reflected by the first reflective surface or the second reflective surface to direct the light to the end face of the light guide member.

4. The decoration device according to claim 1,
wherein the light guide member further includes an exit surface provided on a front surface of the light guide member, and
the end face is formed into a tapered shape so that an inner diameter of the light guide member is decreased toward a front surface thereof in order to refract a part of light reaching the end face from an inside of the light guide member so as to exit toward the diffuse reflective surface and reflect the other part of the light reaching the end face so as to exit from the exit surface.

5. The decoration device according to claim 1, further comprising a cover arranged in front of the diffuse reflective surface,
wherein the cover is formed of a light transmissive member and provided with a plurality of holes through which the diffuse reflective surface can be visually recognized directly from a front side of the cover in which light diffusely reflected by the diffuse reflective surface is further diffused by at least a part of a circumference of the holes.

6. A game machine comprising:
a game machine body; and
a decoration device provided on a surface of the game machine body, the surface facing a player,
the decoration device including
at least one light source emitting light having directivity,
a diffusion member having a diffuse reflective surface for diffusely reflecting light from the light source, and
a light guide member arranged around the diffusion member at a position anterior to the diffuse reflective surface,
the light guide member including at least one incident surface facing the at least one light source and an end face facing the diffusion member, wherein
the light guide member causes light from the light source, the light entering the light guide member through the incident surface, to propagate so as to spread within the light guide member, so that the light from the light source exits from an area of the end face, the area being larger than the incident surface, toward the diffuse reflective surface.
